(19) United States
(12) Patent Application Publication
(10) Pub. No.: US 2026/0302120 A1
(43) Pub. Date: Oct. 1, 2026

(54) FUSE UNIT AND CONDUCTIVE MODULE

(71) Applicant: YAZAKI CORPORATION, Tokyo (JP)

(72) Inventors: Mariko Nakagawa, Makinohara-shi (JP); Katsunori Sato, Makinohara-shi (JP); Yasuhiro Kominato, Makinohara-shi (JP); Miho Suzuki, Makinohara-shi (JP); Kota Morishige, Makinohara-shi (JP)

(21) Appl. No.: 19/574,235

(22) Filed: Mar. 20, 2026

(30) Foreign Application Priority Data
Mar. 25, 2025 (JP) 2025-049798

(51) Int. Cl. H01H 85/143; H01H 85/055

(52) U.S. Cl. CPC H01H 85/143; H01H 85/055

(57) ABSTRACT

A fuse unit includes a circuit protection component between a first electrical connection target (first metal material) and a second electrical connection target, a first terminal fitting (second metal material) that connects a first electrical connection portion to a first electrode of the circuit protection component, a second terminal fitting (second metal material) that connects a second electrical connection portion to a second electrode of the circuit protection component, a wiring component including a conductor portion (second metal material) to be connected to the second terminal fitting between the second terminal fitting and the second electrical connection target, a coupling terminal fitting (first metal material) having a conductor connection portion to be connected to the first electrical connection target and a second terminal connection portion to be connected to a first terminal connection portion of the first terminal fitting.

### CROSS-REFERENCE TO RELATED APPLICATION(S)

The present application claims priority to and incorporates by reference the entire contents of Japanese Patent Application No. 2025-049798 filed in Japan on Mar. 25, 2025.

### BACKGROUND OF THE INVENTION

### 1. Field of the Invention

The present invention relates to a fuse unit and a conductive module.

### 2. Description of the Related Art

A conductive module uses a plurality of connecting conductors to electrically connect a plurality of battery cells in a battery module in which a plurality of battery cells are arranged. The conductive module uses a wiring component such as a wire to electrically connect each of the connecting conductors to a battery monitoring unit that monitors a battery state of the battery cells. For example, Japanese Patent Application Laid-open No. JP 2020 – 119 651 A discloses a conductive module of this type. In such a conductive module, a combination of the connecting conductor and a conductor portion of the wiring component in a pair is provided for each connecting conductor, and a circuit protection component such as a fuse may be interposed between the connecting conductor and the conductor portion of the wiring component in each of the combinations. For example, Japanese Patent No. 7 561 318 B1 discloses a fuse unit (with a chip fuse and a pair of terminal fittings) applied to this conductive module.

In a conductive module, the connecting conductor and the conductor portion of the wiring component are not always formed of the same type of metal material. The connecting conductor and the conductor portion may be formed of different types of metal materials. In this case, it is necessary for the fuse unit disposed between the connecting conductor and the conductor portion to serve connections between the different types of metals.

### SUMMARY OF THE INVENTION

It is an object of the present invention to provide a fuse unit and a conductive module that are adapted to the connecting conductor and the conductor portion of the wiring component of different types of metals.

In order to achieve the above mentioned object, a fuse unit according to one aspect of the present invention includes a circuit protection component that melts a fusible portion when an overcurrent flows between a first electrical connection target formed of a first metal material and a second electrical connection target; a first terminal fitting formed of a second metal material as a different type of metal material different from the first metal material, the first terminal fitting directly electrically connecting a first electrical connection portion to a first electrode of the circuit protection component; a second terminal fitting formed of the second metal material, the second terminal fitting directly electrically connecting a second electrical connection portion to a second electrode of the circuit protection component; a wiring component including a conductor portion formed of the second metal material, the conductor portion having one end directly electrically connected to the second terminal fitting and another end directly or indirectly electrically connected to the second electrical connection target; and a coupling terminal fitting having a conductor connection portion and a second terminal connection portion and formed of the first metal material, the conductor connection portion being directly electrically connected to the first electrical connection target, the second terminal connection portion being directly electrically connected to a first terminal connection portion of the first terminal fitting, wherein one of the first terminal connection portion and the second terminal connection portion is formed as an axial shaft portion, and another of the first terminal connection portion and the second terminal connection portion is formed as a crimp portion having two barrel pieces to be squeezed and crimped onto the shaft portion.

In order to achieve the above mentioned object, a fuse unit according to another aspect of the present invention includes a circuit protection component that melts a fusible portion when an overcurrent flows between a first electrical connection target formed of a first metal material and a second electrical connection target; a first terminal fitting formed of the first metal material, the first terminal fitting directly electrically connecting a first electrical connection portion to a first electrode of the circuit protection component; a second terminal fitting formed of a second metal material as a different type of metal material different from the first metal material, the second terminal fitting directly electrically connecting a second electrical connection portion to a second electrode of the circuit protection component; a wiring component including a conductor portion formed of the second metal material, the conductor portion having one end directly electrically connected to the second terminal fitting and another end directly or indirectly electrically connected to the second electrical connection target; and a coupling terminal fitting having a conductor connection portion and a second terminal connection portion and formed of the first metal material, the conductor connection portion being directly electrically connected to the first electrical connection target, the second terminal connection portion being directly electrically connected to a first terminal connection portion of the first terminal fitting, wherein one of the first terminal connection portion and the second terminal connection portion is formed as an axial shaft portion, and another of the first terminal connection portion and the second terminal connection portion is formed as a crimp portion having two barrel pieces to be squeezed and crimped onto the shaft portion.

In order to achieve the above mentioned object, a conductive module according to still another aspect of the present invention includes a connecting conductor formed of a first metal material and directly electrically connected to an electrode terminal of a battery cell constituting a battery module; and a fuse unit that indirectly electrically connects the connecting conductor to a battery monitoring unit that monitors a battery state of the battery cell, wherein the fuse unit includes a circuit protection component that melts a fusible portion when an overcurrent flows between the connecting conductor and the battery monitoring unit, a first terminal fitting formed of a second metal material as a different type of metal material different from the first metal material, the first terminal fitting directly electrically connecting a first electrical connection portion to a first electrode of the circuit protection component, a second terminal fitting formed of the second metal material, the second terminal fitting directly electrically connecting a second electrical connection portion to a second electrode of the circuit protection component, a wiring component including a conductor portion formed of the second metal material, the conductor portion having one end directly electrically connected to the second terminal fitting and another end directly or indirectly electrically connected to the battery monitoring unit, and a coupling terminal fitting having a conductor connection portion and a second terminal connection portion and formed of the first metal material, the conductor connection portion being directly electrically connected to the connecting conductor, the second terminal connection portion being directly electrically connected to a first terminal connection portion of the first terminal fitting, and one of the first terminal connection portion and the second terminal connection portion is formed as an axial shaft portion, and another of the first terminal connection portion and the second terminal connection portion is formed as a crimp portion having two barrel pieces to be squeezed and crimped onto the shaft portion.

In order to achieve the above mentioned object, a conductive module according to still another aspect of the present invention includes a connecting conductor formed of a first metal material and directly electrically connected to an electrode terminal of a battery cell constituting a battery module; and a fuse unit that indirectly electrically connects the connecting conductor to a battery monitoring unit that monitors a battery state of the battery cell, wherein the fuse unit includes a circuit protection component that melts a fusible portion when an overcurrent flows between the connecting conductor and the battery monitoring unit, a first terminal fitting formed of the first metal material, the first terminal fitting directly electrically connecting a first electrical connection portion to a first electrode of the circuit protection component, a second terminal fitting formed of a second metal material as a different type of metal material different from the first metal material, the second terminal fitting directly electrically connecting a second electrical connection portion to a second electrode of the circuit protection component, a wiring component including a conductor portion formed of the second metal material, the conductor portion having one end directly electrically connected to the second terminal fitting and another end directly or indirectly electrically connected to the battery monitoring unit, and a coupling terminal fitting having a conductor connection portion and a second terminal connection portion and formed of the first metal material, the conductor connection portion being directly electrically connected to the connecting conductor, the second terminal connection portion being directly electrically connected to a first terminal connection portion of the first terminal fitting, and one of the first terminal connection portion and the second terminal connection portion is formed as an axial shaft portion, and another of the first terminal connection portion and the second terminal connection portion is formed as a crimp portion having two barrel pieces to be pressed and crimped onto the shaft portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective overall view of a fuse unit and a conductive module according to an embodiment;

FIG. 2 is a schematic diagram illustrating a battery module together with connecting conductors; and

FIG. 3 is a plan view of the fuse unit and the conductive module according to the embodiment.

### DETAILED DESCRIPTION OF THE PREFERRED EMBODIMENTS

Embodiments of a fuse unit and a conductive module according to the present invention will be described in detail below based on the drawings. The embodiments are not intended to limit this invention.

### Embodiments

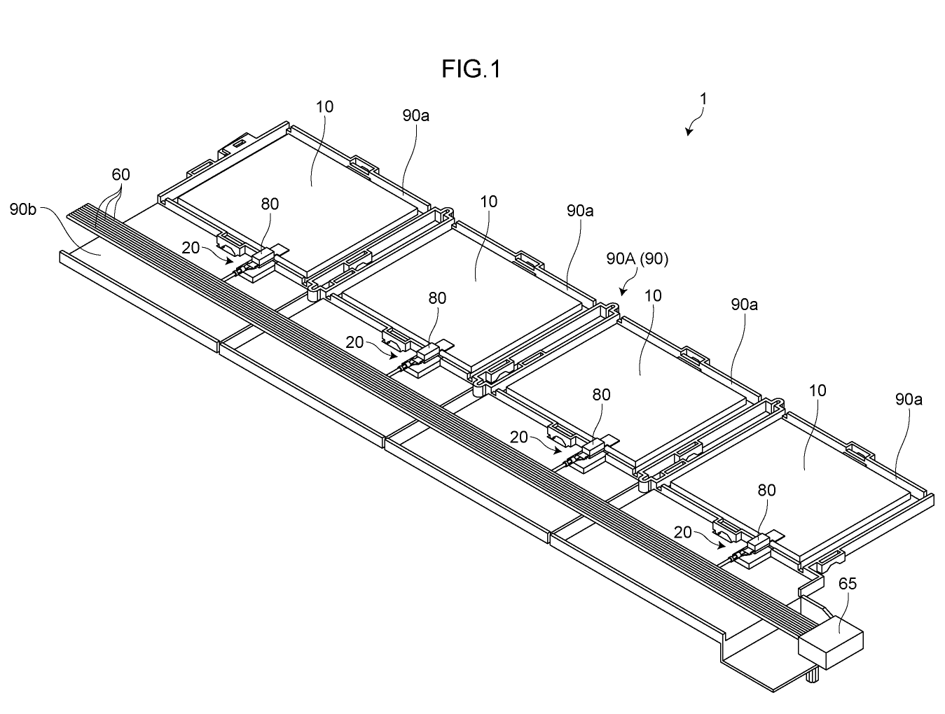

One embodiment of a fuse unit and a conductive module according to the present invention will be described based on FIGS. 1-3.

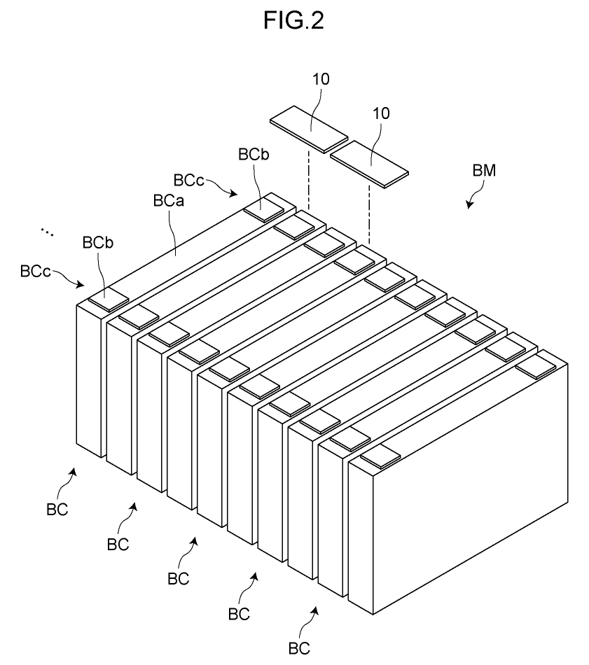

FIG. 1 illustrates a conductive module 1 of the present embodiment. The conductive module 1 is assembled into a battery module BM (FIG. 2) in which a plurality of battery cells BC are arranged, and electrically connects the battery cells BC in the battery module BM. The conductive module 1 also electrically connects the battery module BM to a battery monitoring unit (not illustrated), thereby allowing the battery monitoring unit to monitor a battery state of the battery cells BC. The conductive module 1 and the battery module BM constitute a battery pack. The battery pack is installed, for example, in a vehicle (BEV: Battery Electric Vehicle, HEV: Hybrid Electric Vehicle, etc.) with a rotating machine as a drive source, and is used to supply power to the rotating machine.

The battery cells BC each have a cell body BCa and positive and negative electrode terminals BCb (FIG. 2). In the battery module BM, a plurality of battery cells BC are arranged in a row along an array direction. The battery module BM includes a first electrode terminal group BCc in which first electrode terminals BCb of the battery cells BC are arranged along the array direction, and a second electrode terminal group BCc in which second electrode terminals BCb of the battery cells BC are arranged along the array direction (FIG. 2).

The term "array direction" hereinafter refers to the array direction of a plurality of battery cells BC or the array direction of a plurality of electrode terminals BCb in the electrode terminal group BCc, unless otherwise specified.

The battery cell BC described here has a box-shaped cell body BCa with six outer wall surfaces. In a plurality of battery cells BC, the cell bodies BCa adjacent to each other in the array direction are disposed such that their respective outer wall surfaces face each other. For example, in the battery cell BC, the positive and negative electrode terminals BCb are disposed on one of the six outer wall surfaces of the cell body BCa or separately disposed on two of the six outer wall surfaces of the cell body BCa. In this example, each battery cell BC has positive and negative electrode terminals BCb on one of the six outer wall surfaces of the cell body BCa (FIG. 2). Thus, in the battery module BM, two electrode terminal groups BCc are provided on one plane (FIG. 2).

The electrode terminal BCb described here is formed in the shape of a flat plate and is directly electrically connected to a connecting conductor 10 described below by laser welding or the like (FIG. 2). However, the electrode terminal BCb may be formed in the shape of a polar column with a male screw portion. In this case, the connecting conductor 10 is screwed and secured to the electrode terminal BCb by screwing a female threaded member to the male screw portion of the electrode terminal BCb.

The conductive module 1 includes connecting conductors 10 that are each directly electrically connected to the electrode terminal BCb of the battery cell BC constituting the battery module BM (FIGS. 1-3).

The connecting conductor 10 is formed of a metal material. The connecting conductor 10 is a metal plate-shaped conductive component called a busbar, which is, for example, press-formed from a metal plate as a base material. The connecting conductor 10 described here is formed in the shape of a rectangular flat plate.

The conductive module 1 includes, for example, as the connecting conductors 10, one that is directly electrically connected to the adjacent electrode terminals BCb of a pair of battery cells BC in the battery module BM, one that is directly electrically connected to the electrode terminal BCb serving as a total negative electrode in the battery module BM, and one that is directly electrically connected to the electrode terminal BCb serving as a total positive electrode in the battery module BM.

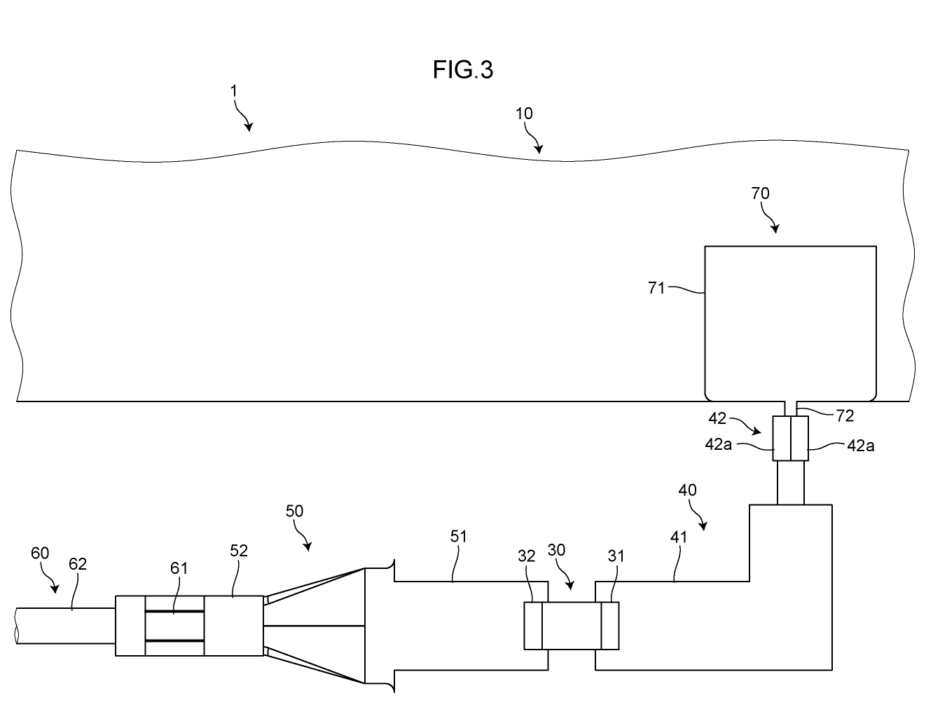

The conductive module 1 includes a fuse unit 20 that indirectly electrically connects the connecting conductor 10 to a battery monitoring unit (FIGS. 1 and 3). The fuse unit 20 indirectly electrically connects the connecting conductor 10 as a first electrical connection target to the battery monitoring unit as a second electrical connection target, and interrupts electric current when an overcurrent flows between the connecting conductor 10 and the battery monitoring unit. The fuse unit 20 is provided for each connecting conductor 10.

The fuse unit 20 includes a circuit protection component 30 that melts a fusible portion when an overcurrent flows between the connecting conductor 10 and the battery monitoring unit (FIG. 3). The circuit protection component 30 includes a first electrode 31 and a second electrode 32 with the fusible portion disposed therebetween (FIG. 3). The first electrode 31 and the second electrode 32 are disposed on a straight line, separately at one end and at the other end of the circuit protection component 30.

The circuit protection component 30 may be configured, for example, as a chip fuse having a fusible portion or as a pattern fuse in which a wiring pattern having a fusible portion is provided on a printed circuit board (e.g., flexible printed circuit board). The circuit protection component 30 described here is configured as a box-shaped chip fuse. The first electrode 31 is provided across five outer wall surfaces at one end of the circuit protection component 30. The second electrode 32 is provided across five outer wall surfaces at the other end of the circuit protection component 30.

The fuse unit 20 includes a first terminal fitting 40 to be indirectly electrically connected to the circuit protection component 30 and a second terminal fitting 50 to be indirectly electrically connected the battery monitoring unit (FIG. 3). The first terminal fitting 40 and the second terminal fitting 50 are formed of a metal material. For example, the first terminal fitting 40 and the second terminal fitting 50 are press-formed from a metal plate as a base material.

The first terminal fitting 40 has a first electrical connection portion 41 to be directly electrically connected to the first electrode 31 of the circuit protection component 30 (FIG. 3). The first electrical connection portion 41 is formed in the shape of a flat plate, and the first electrode 31 is directly electrically connected to one of two planes of the flat plate by laser welding, soldering, or the like. The first electrical connection portion 41 described here is formed in the shape of an L-shaped flat plate and has the first electrode 31 directly electrically connected to one of two pieces that form the L shape.

The second terminal fitting 50 has a second electrical connection portion 51 to be directly electrically connected to the second electrode 32 of the circuit protection component 30 (FIG. 3). The second electrical connection portion 51 is formed in the shape of a flat plate, and the second electrode 32 is directly electrically connected to one of two planes of the flat plate by laser welding, soldering, or the like. The second electrical connection portion 51 described here is formed in the shape of a rectangular flat plate.

The second terminal fitting 50 is indirectly electrically connected to the battery monitoring unit as previously mentioned. The fuse unit 20 includes a wiring component 60 interposed between the second terminal fitting 50 and the battery monitoring unit (FIGS. 1 and 3). The second terminal fitting 50 is indirectly electrically connected to the battery monitoring unit through the wiring component 60. The second terminal fitting 50 has a wiring connection portion 52 to be directly electrically connected to the wiring component 60 (FIG. 3).

The wiring component 60 includes a conductor portion 61 having one end directly electrically connected to the second terminal fitting 50 and the other end directly or indirectly electrically connected to the battery monitoring unit (FIG. 3). The wiring component 60 includes an electrically insulating insulation coating 62 that covers at least one end closer to the battery monitoring unit in the conductor portion 61 at the terminal (FIG. 3). The wiring component 60 described here is a linear conductor having the linearly formed conductor portion 61. Specifically, the wiring component 60 is a wire having a core as the conductor portion 61 covered with the electrically insulating insulation coating 62. The wiring connection portion 52 is directly electrically connected to one end of the conductor portion 61 at the terminal.

For example, in the wiring component 60, the insulation coating 62 is stripped off at the terminal to expose one end of the conductor portion 61. In this case, the wiring connection portion 52 may be formed as a press-fit crimp portion to be squeezed and crimped onto one end of the conductor portion 61 (i.e., the core at the terminal of the wire). For example, the wiring component 60 may be covered with the insulating coating 62 to one end of the conductor portion 61 at the terminal. In this case, the wiring connection portion 52 may be formed as a pair of pressure-welding blades to hold one end (the core at the terminal of the wire) of the conductor portion 61 with the insulation coating 62 cut at the terminal of the wiring component 60. The wiring connection portion 52 described here is formed as a press-fit crimp portion.

The second terminal fitting 50 described here has the second electrical connection portion 51 and the wiring connection portion 52 adjacent to each other. The wiring connection portion 52 pulls out the wiring component 60 in a direction adjacent thereto and along the plane of the second electrical connection portion 51.

The wiring component 60 may be a flat wiring material such as a flexible printed circuit board having the conductor portion 61 formed as a wiring pattern (not illustrated). In this case, the wiring component 60 has the conductor portion 61 for each of the second terminal fittings 50 in a plurality of fuse units 20, and one end of the conductor portion 61 is provided at a terminal of a branch section that branches from the body to each second terminal fitting 50. The one end of the conductor portion 61 is directly electrically connected to the wiring connection portion 52, for example, by laser welding, soldering, or the like.

In the fuse unit 20 and the conductive module 1, a coupling terminal fitting 70 is interposed between the connecting conductor 10 and the first terminal fitting 40, and the connecting conductor 10 and the first terminal fitting 40 are indirectly electrically connected through the coupling terminal fitting 70 (FIG. 3). The coupling terminal fitting 70 is formed of a metal material.

The coupling terminal fitting 70 has a conductor connection portion 71 to be directly electrically connected to the connecting conductor 10 (FIG. 3). The conductor connection portion 71 is formed in the shape of a flat plate and is placed on the connecting conductor 10 with their planes superimposed on each other. The conductor connection portion 71 is directly electrically connected to the connecting conductor 10 by laser welding, ultrasonic bonding, or the like. The conductor connection portion 71 described here is formed in the shape of a rectangular flat plate.

The coupling terminal fitting 70 also has a second terminal connection portion 72 to be directly electrically connected to a first terminal connection portion 42 of the first terminal fitting 40 (FIG. 3). One of the first terminal connection portion 42 and the second terminal connection portion 72 is formed as an axial shaft portion, and the other of them is formed as a crimp portion having two barrel pieces to be squeezed and crimped onto the shaft portion.

In this example, the first terminal connection portion 42 is formed as the crimp portion having two barrel pieces 42a, and the second terminal connection portion 72 is formed as the shaft portion (FIG. 3). The first terminal connection portion 42 protrudes from the other of the two pieces that form the L shape in the first electrical connection portion 41 on the same plane as the first electrical connection portion 41. The second terminal connection portion 72 protrudes from the conductor connection portion 71 on the same plane as the conductor connection portion 71. The first terminal fitting 40 and the coupling terminal fitting 70 are directly electrically connected by deforming the two barrel pieces 42a and squeezing and crimping the first terminal connection portion 42 onto the second terminal connection portion 72.

Specifically, for example, in the fuse unit 20 and the conductive module 1, the connecting conductor 10 and the coupling terminal fitting 70 are formed of a first metal material. In the fuse unit 20 and the conductive module 1, the first terminal fitting 40, the second terminal fitting 50, and the conductor portion 61 of the wiring component 60 are formed of a second metal material as a different type of metal material different from the first metal material.

The first metal material is aluminum or an aluminum alloy. The second metal material is copper or a copper alloy. In this case, the connecting conductor 10 and the coupling terminal fitting 70, which are both formed of aluminum or an aluminum alloy, are directly electrically connected, for example, by ultrasonically bonding the connecting conductor 10 and the conductor connection portion 71. The first terminal fitting 40 and the coupling terminal fitting 70, which are formed of different types of metal materials, are directly electrically connected by squeezing and crimping the first terminal connection portion 42 onto the second terminal connection portion 72 as previously mentioned. The second terminal fitting 50 and the conductor portion 61 of the wiring component 60, which are both formed of copper or a copper alloy, are directly electrically connected by squeezing and crimping the wiring connection portion 52 onto the conductor portion 61.

Here, the first terminal fitting 40 (copper or a copper alloy) and the second terminal fitting 50 (copper or a copper alloy) have anticorrosion plating on their surfaces. The anticorrosion plating is formed as a plating film, for example, by tin, nickel, silver, or gold plating. This improves the corrosion resistance of the first terminal fitting 40 and the second terminal fitting 50 in the fuse unit 20 and the conductive module 1. Here, for example, the anticorrosion plating is a plating film by tin or nickel plating that has a greater ionization tendency than the first terminal fitting 40 (copper or a copper alloy) and the second terminal fitting 50 (copper or a copper alloy). This reduces the potential difference between the first terminal fitting 40 (copper or a copper alloy) and the coupling terminal fitting 70 (aluminum or an aluminum alloy), thereby suppressing the occurrence of galvanic corrosion in the coupling terminal fitting 70. In the circuit protection component 30, the first electrode 31 and the second electrode 32 are formed with a plating film, for example, by tin plating, and the first electrode 31 and the second electrode 32 are directly electrically connected by soldering to the first electrical connection portion 41 of the first terminal fitting 40 and the second electrical connection portion 51 of the second terminal fitting 50, respectively. The first terminal fitting 40 (copper or a copper alloy) and the second terminal fitting 50 (copper or a copper alloy) have anticorrosion plating on their surfaces to improve wettability when soldering.

The connecting conductor 10 (aluminum or an aluminum alloy) and the coupling terminal fitting 70 (aluminum or an aluminum alloy) may have anticorrosion plating on their surfaces or may have no anticorrosion plating on their surfaces.

Furthermore, in the fuse unit 20 and the conductive module 1, the first metal material may be copper or a copper alloy, and the second metal material may be aluminum or an aluminum alloy. In this case, the connecting conductor 10 and the coupling terminal fitting 70, which are both formed of copper or a copper alloy, are directly electrically connected, for example, by bonding the connecting conductor 10 and the conductor connection portion 71 by laser welding or the like. The first terminal fitting 40 and the coupling terminal fitting 70, which are formed of different types of metal materials, are directly electrically connected by squeezing and crimping the first terminal connection portion 42 onto the second terminal connection portion 72 as previously mentioned. The second terminal fitting 50 and the conductor portion 61 of the wiring component 60, which are both formed of aluminum or an aluminum alloy, are directly electrically connected by squeezing and crimping the wiring connection portion 52 onto the conductor portion 61.

In this case, the connecting conductor 10 (copper or a copper alloy) and the coupling terminal fitting 70 (copper or a copper alloy) have anticorrosion plating on their surfaces. The anticorrosion plating is formed as a plating film, for example, by tin, nickel, silver, or gold plating. This improves the corrosion resistance of the connecting conductor 10 and the coupling terminal fitting 70 in the fuse unit 20 and the conductive module 1. Here, for example, the anticorrosion plating is a plating film by tin or nickel plating that has a greater ionization tendency than the connecting conductor 10 (copper or a copper alloy) and the coupling terminal fitting 70 (copper or a copper alloy). This reduces the potential difference between the first terminal fitting 40 (aluminum or an aluminum alloy) and the coupling terminal fitting 70 (copper or a copper alloy), thereby suppressing the occurrence of galvanic corrosion in the first terminal fitting 40.

In this case, it is desirable to provide anticorrosion plating on the surfaces of the first terminal fitting 40 (aluminum or an aluminum alloy) and the second terminal fitting 50 (aluminum or an aluminum alloy). For example, as previously mentioned, in the circuit protection component 30, the first electrode 31 and the second electrode 32 are formed with a plating film, for example, by tin plating, and the first electrode 31 and the second electrode 32 are directly electrically connected by soldering to the first electrical connection portion 41 of the first terminal fitting 40 and the second electrical connection portion 51 of the second terminal fitting 50, respectively. Therefore, the first terminal fitting 40 (aluminum or an aluminum alloy) and the second terminal fitting 50 (aluminum or an aluminum alloy) can have anticorrosion plating on their surfaces to improve wettability when soldering.

Instead of these various forms, in the fuse unit 20 and the conductive module 1, for example, the connecting conductor 10, the first terminal fitting 40, and the coupling terminal fitting 70 may be formed of a first metal material, and the second terminal fitting 50 and the conductor portion 61 of the wiring component 60 may be formed of a second metal material as a different type of metal material different from the first metal material.

The first metal material is aluminum or an aluminum alloy. The second metal material is copper or a copper alloy. In this case, the connecting conductor 10 and the coupling terminal fitting 70, which are both formed of aluminum or an aluminum alloy, can be directly electrically connected, for example, by ultrasonically bonding the connecting conductor 10 and the conductor connection portion 71, in the same manner as the above example. The first terminal fitting 40 and the coupling terminal fitting 70, which are both formed of aluminum or an aluminum alloy, can be directly electrically connected by squeezing and crimping the first terminal connection portion 42 onto the second terminal connection portion 72, as previously mentioned. The second terminal fitting 50 and the conductor portion 61 of the wiring component 60, which are both formed of copper or a copper alloy, are directly electrically connected by squeezing and crimping the wiring connection portion 52 onto the conductor portion 61.

Here, the second terminal fitting 50 (copper or a copper alloy) has anticorrosion plating on its surface. The anticorrosion plating is formed as a plating film, for example, by tin, nickel, silver, or gold plating. Here, it is desirable to provide anticorrosion plating even on the surface of the first terminal fitting 40 (aluminum or an aluminum alloy). For example, as previously mentioned, in the circuit protection component 30, the first electrode 31 and the second electrode 32 are formed with a plating film, for example, by tin plating, and the first electrode 31 and the second electrode 32 are directly electrically connected by soldering to the first electrical connection portion 41 of the first terminal fitting 40 and the second electrical connection portion 51 of the second terminal fitting 50, respectively. Therefore, the first terminal fitting 40 (aluminum or an aluminum alloy) and the second terminal fitting 50 (copper or a copper alloy) can have anticorrosion plating on their surfaces to improve wettability when soldering.

The connecting conductor 10 (aluminum or an aluminum alloy) and the coupling terminal fitting 70 (aluminum or an aluminum alloy) may have anticorrosion plating on their surfaces or may have no anticorrosion plating on their surfaces.

Furthermore, in the fuse unit 20 and the conductive module 1, the first metal material may be copper or a copper alloy, and the second metal material may be aluminum or an aluminum alloy. In this case, the connecting conductor 10 and the coupling terminal fitting 70, which are both formed of copper or a copper alloy, can be directly electrically connected, for example, by bonding the connecting conductor 10 and the conductor connection portion 71 by laser welding or the like, in the same manner as in the above example. The first terminal fitting 40 and the coupling terminal fitting 70, which are both formed of copper or a copper alloy, can be directly electrically connected by squeezing and crimping the first terminal connection portion 42 onto the second terminal connection portion 72, as previously mentioned. The second terminal fitting 50 and the conductor portion 61 of the wiring component 60, which are both formed of aluminum or an aluminum alloy, can be directly electrically connected by squeezing and crimping the wiring connection portion 52 onto the conductor portion 61.

In this case, the connecting conductor 10 (copper or a copper alloy), the first terminal fitting 40 (copper or a copper alloy), and the coupling terminal fitting 70 (copper or a copper alloy) have anticorrosion plating on their surfaces. The anticorrosion plating is formed as a plating film, for example, by tin, nickel, silver, or gold plating. This improves the corrosion resistance of the connecting conductor 10, the first terminal fitting 40, and the coupling terminal fitting 70 in the fuse unit 20 and the conductive module 1. Here, it is desirable to provide anticorrosion plating even on the surface of the second terminal fitting 50 (aluminum or an aluminum alloy). For example, as previously mentioned, in the circuit protection component 30, the first electrode 31 and the second electrode 32 are formed with a plating film, for example, by tin plating, and the first electrode 31 and the second electrode 32 are directly electrically connected by soldering to the first electrical connection portion 41 of the first terminal fitting 40 and the second electrical connection portion 51 of the second terminal fitting 50, respectively. Therefore, the first terminal fitting 40 (copper or a copper alloy) and the second terminal fitting 50 (aluminum or an aluminum alloy) can have anticorrosion plating on their surfaces to improve wettability when soldering.

The fuse unit 20 has an electrically insulating coating resin portion 80 that encapsulates the first electrical connection portion 41, the second electrical connection portion 51, and the circuit protection component 30 (FIG. 1). The coating resin portion 80 encapsulates the first electrical connection portion 41, the second electrical connection portion 51, and the circuit protection component 30 to suppress electric current between the first electrical connection portion 41 and the second electrical connection portion 51. The coating resin portion 80 can, for example, suppress a short circuit between the first electrical connection portion 41 and the second electrical connection portion 51 due to condensation water. For example, the coating resin portion 80 is a solidified product of a liquid resin material (so-called UV-curable or thermosetting potting material) that is supplied by dropping or the like to encapsulate the first electrical connection portion 41, the second electrical connection portion 51, and the circuit protection component 30.

The conductive module 1 of the present embodiment includes a housing component (hereinafter referred to as "module housing component") 90 that is assembled into the battery module BM and accommodates the connecting conductors 10 and the fuse units 20 (FIG. 1).

The module housing component 90 has a housing chamber (hereinafter referred to as the "conductor housing chamber") 90a that accommodates the connecting conductor 10, and a housing chamber (hereinafter referred to as "unit housing chamber") 90b that accommodates the fuse unit 20 (FIG. 1). For example, the module housing component 90 has the conductor housing chamber 90a for each connecting conductor 10 connected to the electrode terminals BCb of each of the electrode terminal groups BCc. On the other hand, the module housing component 90 has the unit housing chamber 90b that collectively accommodates the fuse unit 20 for each connecting conductor 10.

In the unit housing chamber 90b, the wiring component 60 (wire) of each of the fuse units 20 is led to the battery monitoring unit. In each of the wiring components 60 (wires), the other end led to the battery monitoring unit is connected to a connector 65 (FIG. 1). Each of the wiring components 60 (wires) is indirectly electrically connected to the battery monitoring unit through the connector 65.

When the wiring component 60 is a flat wiring material, the unit housing chamber 90b accommodates the wiring component 60 (flat wiring material) having the conductor portion 61 connected to the second terminal fitting 50 of each of the fuse units 20 (not illustrated).

For example, the module housing component 90 includes a first housing member (hereinafter referred to as "first module housing member") 90A (FIG. 1) and a second housing member (hereinafter referred to as "second module housing member" not illustrated) which are assembled and secured to each other. The first module housing member 90A and the second module housing member are formed of an electrically insulating material such as a synthetic resin.

The first module housing member 90A has spaces for forming a plurality of conductor housing chambers 90a and the unit housing chamber 90b at an assemble completion position with the second module housing member. The second module housing member is formed as a cover member that covers the openings of the spaces.

As described above, the fuse unit 20 of the present embodiment can make direct electrical connections between the components between the connecting conductor 10 and the conductor portion 61 of the wiring component 60 when the connecting conductor 10 and the conductor portion 61 of the wiring component 60 are formed of different types of metal materials, so that the connecting conductor 10 and the conductor portion 61 of the wiring component 60 can be indirectly electrically connected to each other. The conductive module 1 of the present embodiment includes the fuse unit 20 and can achieve the same effects as those obtained with the fuse unit 20.

The fuse unit according to the present embodiment can make direct electrical connections between the components between the connecting conductor and the conductor portion of the wiring component when the connecting conductor and the conductor portion of the wiring component are formed of different types of metal materials, so that the connecting conductor and the conductor portion of the wiring component can be indirectly electrically connected to each other. The conductive module according to the present embodiment includes the fuse unit and can achieve the same effects as those obtained with the fuse unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit comprising:
a circuit protection component that melts a fusible portion when an overcurrent flows between a first electrical connection target formed of a first metal material and a second electrical connection target;
a first terminal fitting formed of a second metal material as a different type of metal material different from the first metal material, the first terminal fitting directly electrically connecting a first electrical connection portion to a first electrode of the circuit protection component;
a second terminal fitting formed of the second metal material, the second terminal fitting directly electrically connecting a second electrical connection portion to a second electrode of the circuit protection component;
a wiring component including a conductor portion formed of the second metal material, the conductor portion having one end directly electrically connected to the second terminal fitting and another end directly or indirectly electrically connected to the second electrical connection target; and
a coupling terminal fitting having a conductor connection portion and a second terminal connection portion and formed of the first metal material, the conductor connection portion being directly electrically connected to the first electrical connection target, the second terminal connection portion being directly electrically connected to a first terminal connection portion of the first terminal fitting, wherein
one of the first terminal connection portion and the second terminal connection portion is formed as an axial shaft portion, and another of the first terminal connection portion and the second terminal connection portion is formed as a crimp portion having two barrel pieces to be squeezed and crimped onto the shaft portion.

2. The fuse unit according to claim 1, wherein
the first metal material is aluminum or an aluminum alloy,
the second metal material is copper or a copper alloy, and
the first terminal fitting and the second terminal fitting have anticorrosion plating on surfaces of the first terminal fitting and the second terminal fitting.

3. The fuse unit according to claim 1, wherein
the first metal material is copper or a copper alloy,
the second metal material is aluminum or an aluminum alloy, and
the coupling terminal fitting has anticorrosion plating on a surface of the coupling terminal fitting.

4. A fuse unit comprising:
a circuit protection component that melts a fusible portion when an overcurrent flows between a first electrical connection target formed of a first metal material and a second electrical connection target;
a first terminal fitting formed of the first metal material, the first terminal fitting directly electrically connecting a first electrical connection portion to a first electrode of the circuit protection component;
a second terminal fitting formed of a second metal material as a different type of metal material different from the first metal material, the second terminal fitting directly electrically connecting a second electrical connection portion to a second electrode of the circuit protection component;
a wiring component including a conductor portion formed of the second metal material, the conductor portion having one end directly electrically connected to the second terminal fitting and another end directly or indirectly electrically connected to the second electrical connection target; and
a coupling terminal fitting having a conductor connection portion and a second terminal connection portion and formed of the first metal material, the conductor connection portion being directly electrically connected to the first electrical connection target, the second terminal connection portion being directly electrically connected to a first terminal connection portion of the first terminal fitting, wherein
one of the first terminal connection portion and the second terminal connection portion is formed as an axial shaft portion, and another of the first terminal connection portion and the second terminal connection portion is formed as a crimp portion having two barrel pieces to be squeezed and crimped onto the shaft portion.

5. The fuse unit according to claim 4, wherein
the first metal material is aluminum or an aluminum alloy,
the second metal material is copper or a copper alloy, and
the second terminal fitting has anticorrosion plating on a surface of the second terminal fitting.

6. The fuse unit according to claim 4, wherein
the first metal material is copper or a copper alloy,
the second metal material is aluminum or an aluminum alloy, and
the first terminal fitting and the coupling terminal fitting have anticorrosion plating on surfaces of the first terminal fitting and the coupling terminal fitting.

7. A conductive module comprising:
a connecting conductor formed of a first metal material and directly electrically connected to an electrode terminal of a battery cell constituting a battery module; and
a fuse unit that indirectly electrically connects the connecting conductor to a battery monitoring unit that monitors a battery state of the battery cell, wherein
the fuse unit includes
a circuit protection component that melts a fusible portion when an overcurrent flows between the connecting conductor and the battery monitoring unit,
a first terminal fitting formed of a second metal material as a different type of metal material different from the first metal material, the first terminal fitting directly electrically connecting a first electrical connection portion to a first electrode of the circuit protection component,
a second terminal fitting formed of the second metal material, the second terminal fitting directly electrically connecting a second electrical connection portion to a second electrode of the circuit protection component,
a wiring component including a conductor portion formed of the second metal material, the conductor portion having one end directly electrically connected to the second terminal fitting and another end directly or indirectly electrically connected to the battery monitoring unit, and
a coupling terminal fitting having a conductor connection portion and a second terminal connection portion and formed of the first metal material, the conductor connection portion being directly electrically connected to the connecting conductor, the second terminal connection portion being directly electrically connected to a first terminal connection portion of the first terminal fitting, and
one of the first terminal connection portion and the second terminal connection portion is formed as an axial shaft portion, and another of the first terminal connection portion and the second terminal connection portion is formed as a crimp portion having two barrel pieces to be squeezed and crimped onto the shaft portion.

8. A conductive module comprising:
a connecting conductor formed of a first metal material and directly electrically connected to an electrode terminal of a battery cell constituting a battery module; and
a fuse unit that indirectly electrically connects the connecting conductor to a battery monitoring unit that monitors a battery state of the battery cell, wherein
the fuse unit includes
a circuit protection component that melts a fusible portion when an overcurrent flows between the connecting conductor and the battery monitoring unit,
a first terminal fitting formed of the first metal material, the first terminal fitting directly electrically connecting a first electrical connection portion to a first electrode of the circuit protection component,
a second terminal fitting formed of a second metal material as a different type of metal material different from the first metal material, the second terminal fitting directly electrically connecting a second electrical connection portion to a second electrode of the circuit protection component,
a wiring component including a conductor portion formed of the second metal material, the conductor portion having one end directly electrically connected to the second terminal fitting and another end directly or indirectly electrically connected to the battery monitoring unit, and
a coupling terminal fitting having a conductor connection portion and a second terminal connection portion and formed of the first metal material, the conductor connection portion being directly electrically connected to the connecting conductor, the second terminal connection portion being directly electrically connected to a first terminal connection portion of the first terminal fitting, and
one of the first terminal connection portion and the second terminal connection portion is formed as an axial shaft portion, and another of the first terminal connection portion and the second terminal connection portion is formed as a crimp portion having two barrel pieces to be pressed and crimped onto the shaft portion.
